(19) United States
(12) Patent Application Publication
(10) Pub. No.: US 2012/0174143 A1
(43) Pub. Date: Jul. 5, 2012

(54) Television System with Face Recognition, Multimedia Reproducing System

(75) Inventors: Tai-Chang Yang, Kaohsiung City (TW); Wen-Yan Chang, Hsinchu (TW); Hong-Long Chou, Taipei City (TW)

(73) Assignee: ALTEK CORPORATION, Hsinchu (TW)

(21) Appl. No.: 13/118,029

(22) Filed: May 27, 2011

(30) Foreign Application Priority Data
Dec. 29, 2010 (TW) 099146676

(51) Int. Cl. H04H 60/33

(52) U.S. Cl. 725/10

(57) ABSTRACT

A television system with face recognition, a multimedia reproducing system and a reproducing system control method thereof are disclosed. The multimedia reproducing system comprises a multimedia module, a storage module, an image capture module and a face recognition module. The storage module stores a user's facial feature parameter and watch rate. The face recognition module detects a face image from an image captured by the image capture module, and recognizes the user corresponding to the face image according to the facial feature parameters stored in the storage module. The multimedia module filters the multimedia contents according to the corresponding user's watch rate.

### BACKGROUND OF THE INVENTION

1. Field of the Invention

The present invention relates to a multimedia reproducing system, and more particularly, to a television system, a multimedia reproducing system capable of performing watching preference analysis and program rating control with their face recognition system.

2. Brief Description of the Related Art

For most people, multimedia reproducing systems such as television system or video/audio reproducing system are commonly used nowadays for entertainment. Traditional multimedia reproducing systems allow user to control a function menu by a remote controller. However, it is unfriendly and inconvenient for user to press buttons of the remote control to select items on the function menu in some situations, such as watch rate setting. Further, user must do cross validation for both the remote control and the window interface on the screen during operation, and sometimes must execute multiple steps in menu system. Such cross validation and the multiple-step operation usually increase the operation time and therefore may lead to a result of the users' losing patience and interest.

Besides, a design standard for defining individual watching preference record menu of the existing television systems does not exist yet and therefore users sometimes have to share the preference record menu with others if their television only can provide one watching preference record menu. It is not just lacking individual privacy only, but also amusement in having personal preference record menu as well.

Moreover, many parents are concerned about the program rating problem of their children; when using the remote control to select channels, it is very likely that those programs not suitable for children may appear on screen.

### SUMMARY OF THE INVENTION

In order to overcome the deficiencies of the prior art, an object of the present invention is to provide a television system, a multimedia reproducing system with face recognition function to improve the convenience of using the multimedia reproducing system.

With the above object in mind, the present invention provides a television system with facial recognition function, wherein the television system comprises a television module, a storage module, an image capture module, a face recognition module, a watching preference record module, and a menu generating module. The television module reproduces programs, and the storage module stores at least one user's facial feature parameter. The image capture module captures an image. The face recognition module may detect at least one face image from the image and recognize the user corresponding to the face image according to the facial feature parameter stored in the storage module. The watching preference record module can record the channels and programs that the user has watched and thereby generated a watching preference parameter for that specific user. The menu generating module generates a watching preference menu according to the watching preference parameter and displays the watching preference menu on the television module for the user's reference.

Wherein, the storage module stores a watch rate corresponding to at least one facial feature parameter and the television module filters the programs according to the corresponding user's watch rate.

With the above object in mind, the present invention provides a multimedia reproducing system with face recognition function, wherein the multimedia reproducing system comprises a multimedia module, a storage module, an image capture module, and a face recognition module. The multimedia module may filter and reproducing multimedia content according to a corresponding user's watch rate. The storage module stores at least one user's facial feature parameter and watch rate. The image capture module captures an image, and the face recognition module may detect at least one face image from the image and recognizing the user corresponding to the face image according to the facial feature parameter stored in the storage module.

Wherein, the multimedia module is preferably a television module, and the multimedia contents of various watch rates are programs of various ratings.

Wherein, the multimedia reproducing system further comprises a watching preference record module recording the channels and programs that a user has watched and thereby generating a watching preference parameter for that specific user.

Wherein, the multimedia reproducing system further comprises a menu generating module for generating a watching preference menu according to the watching preference parameter and displaying the watching preference menu on the multimedia module for the user's reference.

Wherein, the multimedia module is preferably a video/audio reproducing module and the multimedia contents of various watch rates are video CDs of various ratings.

Wherein, the storage module further stores a priority data and facial feature parameters of a plurality of users; as the face recognition module recognizes more than one user from the image, the multimedia module will determine the multimedia content according to the priority data and the watch rate of the corresponding users.

### BRIEF DESCRIPTION OF THE DRAWINGS

FIG. 1 shows a block diagram of the television system according to an embodiment of the present invention;

FIG. 2 shows a block diagram of the multimedia reproducing system according to the embodiment of the present invention;

FIG. 3 shows a flow chart of the reproducing system control method according to the first embodiment of the present invention; and

FIG. 4 shows a flow chart of the reproducing system control method according to the second embodiment of the present invention.

### DETAILED DESCRIPTION OF THE PREFERRED EMBODIMENTS

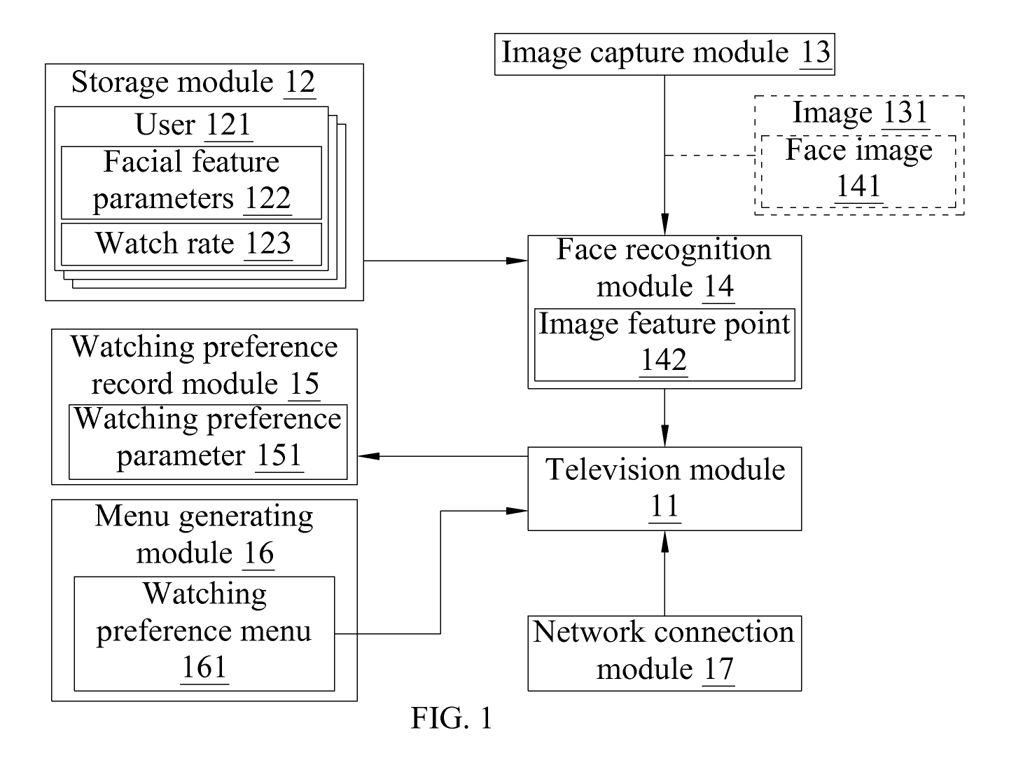

FIG. 1 illustrates a block diagram of a television system according to an embodiment of the present invention. The television system comprises a television module 11, a storage module 12, an image capture module 13, a face recognition module 14, a watching preference record module 15, a menu generating module 16 and a network connection module 17. The television module 11 reproduces programs, and the storage module 12 can store a plurality of facial feature parameter 122 and watch rate 123 of registered users 121. The image capture module 13 captures an image 131. Wherein, the image capture module 13 is preferably an image sensor, such as charge coupled device (CCD) or complementary metal oxide semiconductor (CMOS). The watch rate 123 includes G-Rated (General Audiences), PG-Rated (Parental Guidance), PG-13-Rated (Parents Strongly Cautioned), and R-Rated (Restricted); wherein the watch rate 123 is the set program rating level which the user 121 is allowed to watch or determined by the television module 11 according to the age of the user 121 and the various age requirements of various program ratings.

The face recognition module 14 detects from image 131 at least one face image 141 and extracts an image feature point 142 from the face image 141; the image feature point 142 and the face feature parameter 122 stored in the storage module 12 are then compared to determine whether the face image 141 is a registered user 121. The face feature parameter 122, the image feature point 142 and the facial recognition method are obvious to one having ordinary skill in the art at the time of the invention and therefore are not described hereinafter.

The face feature parameter 122 of a user 121 registered in the television system 1 is a built-in data; as the face recognition module 14 detects an unregistered user in the image 131, it activates a register process setting the image feature point 142 as the new user's face feature parameter and stores the face feature parameter in the storage module 12 and the new user is then registered. The register process is performed automatically by the television system or manually by the users.

When the face recognition module 14 recognizes a registered user 121 in the image 131, that means there is a registered user 121 watching programs. Therefore, the watching preference record module 15 is activated to record programs that the user 121 has watched and then analyzes the statistics and thereby generates a watching preference parameter 151 of the user 121. In practice, the watching preference parameter 151 includes related information, time, or switching frequency of the programs that the user 121 has watched. The menu generating module 16 generates a watching preference menu 161 according to the watching preference parameter 151 and displays the watching preference menu 161 on the television module 11 for the user's information. The user 121 can operate the watching preference menu 161 directly to select the desired programs effectively.

Besides, as the television system is not activated to reproduce programs, the network connection module 17 with a mobile network function is capable of reminding the user of the reproducing time of programs or suggesting the users to activate a prerecord system according to the watching preference menu 161. The television system of the present invention thus allows users to watch their favorite programs without having to be troubled with complicated operation steps on remote controls.

Moreover, as the face recognition module 14 recognizes the registered user 121 in the image 131, the television module 11 will filter the programs according to the corresponding user 121's watch rate 123. When the watch rate 123 of the user 121 is of G-Rated only, the television module 11 will automatically filter out those programs of PG-Rated, PG-13-Rated and R-Rated. Therefore, parents are required to manually adjust the program filtration settings to avoid their children being provided with inappropriate programs. The foregoing register process also includes setting up the watch rate 123 of the users.

Further, as the face recognition module 14 detects no face image in the image 131 when the television module 11 is activated, it means no one is currently watching the television and therefore the television module 11 will be automatically shut down.

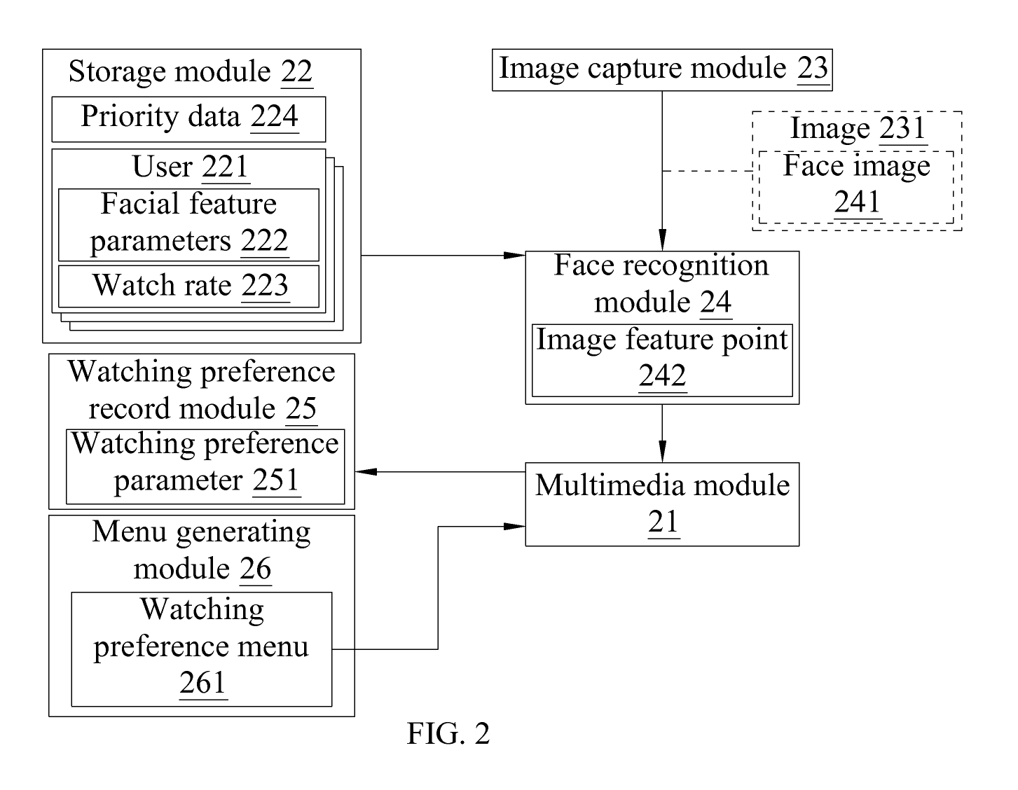

FIG. 2 illustrates a block diagram of multimedia reproducing system according to the embodiment of the present invention. The multimedia reproducing system with face recognition function comprises a multimedia module 21, a storage module 22, an image capture module 23, a face recognition module 24, a watching preference record module 25 and a menu generating module 26. The multimedia module 21 reproduces multimedia contents of various ratings. The multimedia module 21 can be a television module. Wherein, the multimedia contents of various watch rates are programs of various ratings such as G-Rated, PG-Rated, PG-13-Rated and R-Rated. The multimedia module 21 can also be a video/audio reproducing module, and the multimedia contents of various watch rates are video CDs of various ratings. The storage module 22 stores a priority data 224 and facial feature parameters 222 and watch rate 223 of a plurality of users 221.

The image capture module 23 captures an image 231 and the face recognition module 24 detects at least one face image 241 from the image 231 and then recognizes the user 221 corresponding to the face image 241 according to the facial feature parameter 222. The multimedia module 21 filters the multimedia contents according to the corresponding watch rate of the user 221. As the face recognition module 24 recognizes more than one user 221 from the image 231, the multimedia module 21 will determine the multimedia content according to the priority data 224 and the watch rate of the corresponding users 221. Wherein, the functions of the watching preference record module 25 and the menu generating module 26 are similar to the watching preference record module 15 and the menu generating module 16, each generates a watching preference parameter 251 and a watching preference menu 261 respectively; therefore the details are not to be described again hereinafter.

If a lower level 223 is set to have priority in the priority data 224, which means when a user that is only allowed to watch G-Rated programs and a user that is allowed to watch all programs are watching together, the multimedia module 21 will filter out those programs of PG-Rated, PG-13-Rated or R-Rated ratings and only show the G-Rated programs. Therefore, parents no longer have to worry about their children being provided with inappropriate programs. Further, if mother is set to have priority over father in the priority data 224, the multimedia module 21 will show mother's watching preference menu when mother and father are watching together.

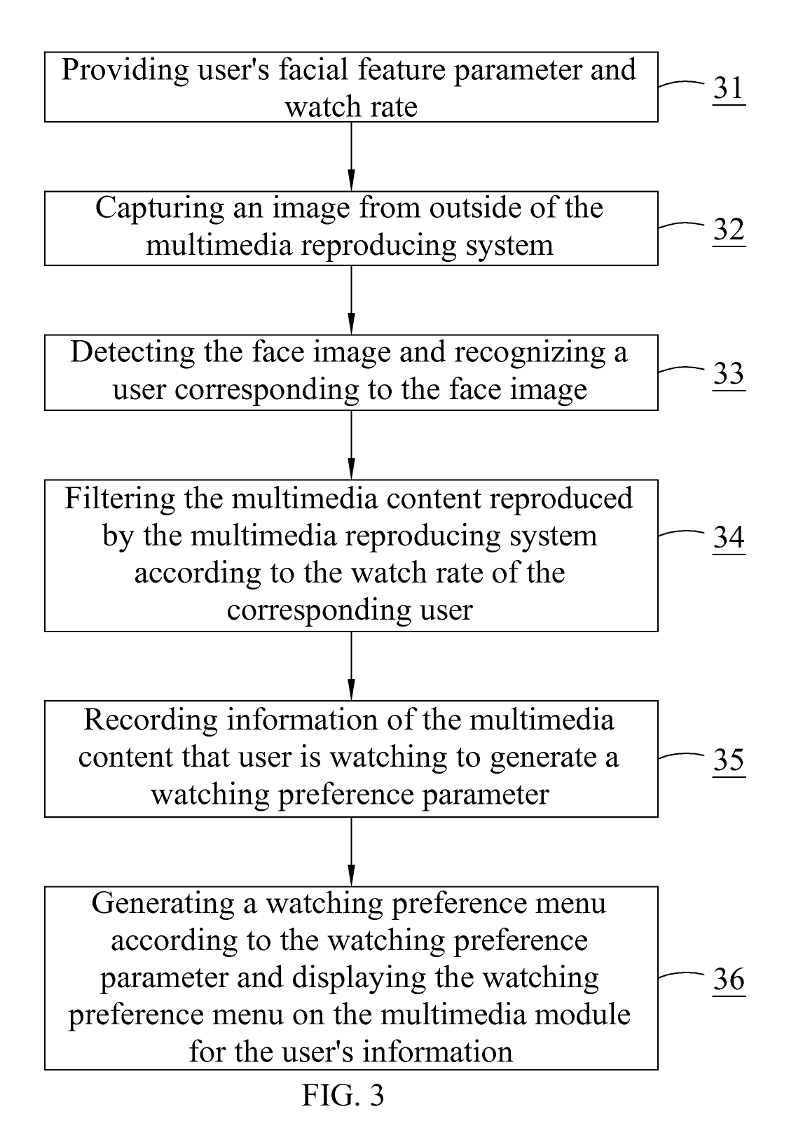

FIG. 3 illustrates a flow chart of a reproducing system control method for controlling the multimedia reproducing system capable of reproducing various multimedia contents of various ratings according to a first embodiment of the present invention, wherein the reproducing system control method comprises following steps. In step 31, at least one user's facial feature parameter and watch rate are provided. In step 32, an image from outside of the multimedia reproducing system is captured. Preferably, an image sensor, such as charge coupled device (CCD) or complementary metal oxide semiconductor (CMOS), can be used for capturing the image. In step 33, at least one face image is detected from the image and a user corresponding to the face image is recognized according to at least one facial feature parameter.

In step 34, the multimedia content reproduced by the multimedia reproducing system is filtered according to the watch rate of the corresponding user. In step 35, the information of the multimedia content that the user is watching is recorded to generate a watching preference parameter. In step 36, a watching preference menu is generated according to the watching preference parameter and the watching preference menu is displayed on the multimedia module for the user's information. Further, the reproducing system control method is also capable of reminding the user of the reproducing time of programs or suggesting the users to activate a prerecord system according to the watching preference menu.

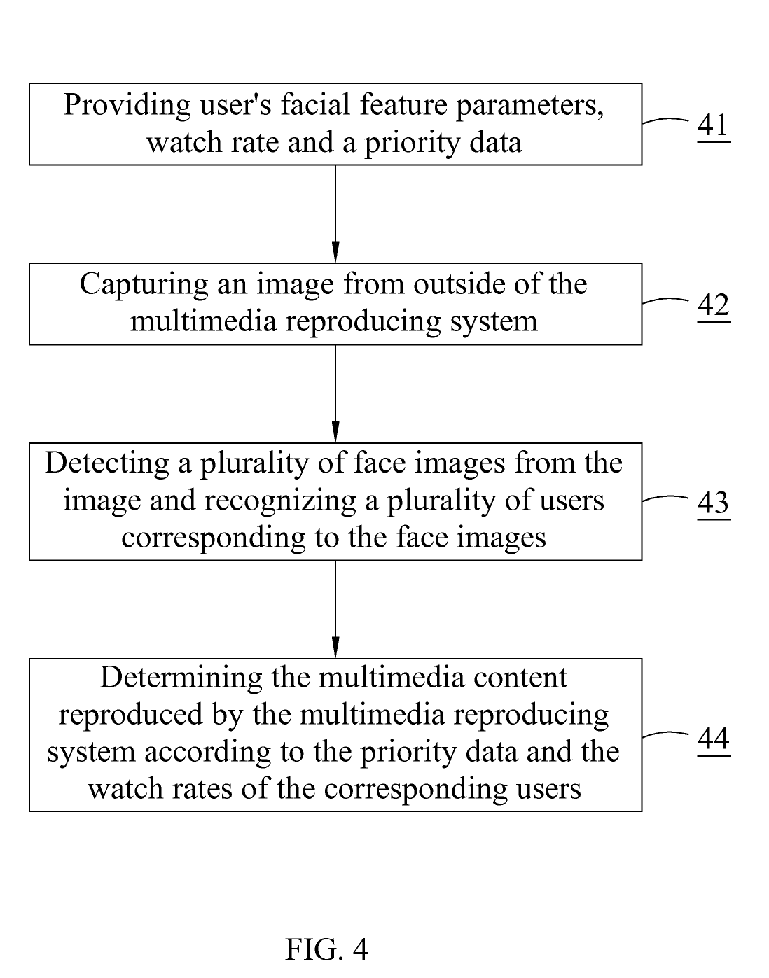

FIG. 4 illustrates a flow chart of the reproducing system control method for controlling the multimedia reproducing system capable of reproducing various multimedia contents of various ratings according to a second embodiment of the present invention; the reproducing system control method comprises following steps. In step 41, facial feature parameters and watch rates of a plurality of users and a priority data are provided. In step 42, an image from outside of the multimedia reproducing system is captured. In step 43, a plurality of face images are detected from the image and a plurality of users corresponding to the face images are recognized according to the facial feature parameters. In step 44, the multimedia content reproduced by the multimedia reproducing system is determined according to the priority data and the watch rates of the corresponding users when a plurality of users is detected from the image. Preferably, the multimedia content is programs or video CDs of various ratings.

While the invention has been described with reference to a preferred embodiment thereof, it is to be understood that modifications or variations may be easily made without departing from the spirit of this invention, which is defined in the appended claims.

What is claimed is:

1. A television system with face recognition function, comprising:
a television module arranged for reproducing programs;
a storage module arranged for storing at least one user's facial feature parameter;
an image capture module arranged for capturing an image;
a face recognition module arranged for detecting at least one face image contained in the image and recognizing the user corresponding to the face image according to the facial feature parameter stored in the storage module;
a watching preference record module arranged for recording information of the programs that the user has watched and generating a watching preference parameter for the user; and
a menu generating module arranged for generating a watching preference menu according to the watching preference parameter and displaying the watching preference menu on the television module for the user's reference.

2. The television system with face recognition function according to claim 1, wherein the storage module stores a watch rate, the watch rate defining an access level of the programs, corresponding to at least one facial feature parameter and the television module filters the programs according to the corresponding user's watch rate.

3. A multimedia reproducing system with face recognition function, comprising:
a multimedia module arranged for reproducing multimedia contents of various ratings;
a storage module arranged for storing at least one user's facial feature parameter and a watch rate, the watch rate defining an access level of the multimedia contents;
an image capture module arranged for capturing an image; and
a face recognition module capable of detecting at least one face image from the image and recognizing the user corresponding to the face image according to the facial feature parameter stored in the storage module;
wherein the multimedia module filters the multimedia contents according to the corresponding user's watch rate.

4. The multimedia reproducing system with face recognition function according to claim 3, wherein the multimedia module is a television module and the multimedia contents of various watch rates are programs of various ratings.

5. The multimedia reproducing system with face recognition function according to claim 4, further comprising a watching preference record module for recording the programs that a user has watched to generate a watching preference parameter for that specific user.

6. The multimedia reproducing system with face recognition function according to claim 5, further comprising a menu generating module for generating a watching preference menu according to the watching preference parameter and displaying the watching preference menu on the multimedia module for the user's information.

7. The multimedia reproducing system with face recognition function according to claim 3, wherein the multimedia module is a video/audio reproducing module and the multimedia contents of various watch rates are video CDs of various ratings.

8. The multimedia reproducing system with face recognition function according to claim 3, wherein the storage module further stores priority data and facial feature parameters of a plurality of users; as the face recognition module recognizes more than one user from the image, the multimedia module will determine the multimedia content according to the priority data and the watch rate of the corresponding users.

9. A multimedia reproducing system with face recognition function, comprising:
a multimedia module arranged for reproducing multimedia contents of various ratings;
a storage module arranged for storing at least one user's facial feature parameter and a watch rate, the watch rate defining an access level of the multimedia contents;
means for capturing an image; and
means for detecting at least one face image from the image and recognizing the user corresponding to the face image according to the facial feature parameter stored in the storage module;
wherein the multimedia module filters the multimedia contents according to the corresponding user's watch rate.

10. The multimedia reproducing system with face recognition function according to claim 9, wherein the multimedia module is a television module and the multimedia contents of various watch rates are programs of various ratings.

11. The multimedia reproducing system with face recognition function according to claim 10, further comprising means for recording the programs that a user has watched to generate a watching preference parameter for that specific user.

12. The multimedia reproducing system with face recognition function according to claim 11, further comprising means for generating a watching preference menu according to the watching preference parameter and displaying the watching preference menu on the multimedia module for the user's information.

13. The multimedia reproducing system with face recognition function according to claim 9, wherein the multimedia module is a video/audio reproducing module and the multimedia contents of various watch rates are video CDs of various ratings.

14. The multimedia reproducing system with face recognition function according to claim 9, wherein the storage module further stores priority data and facial feature parameters of a plurality of users; as the face recognition module recognizes more than one user from the image, the multimedia module will determine the multimedia content according to the priority data and the watch rate of the corresponding users.
